(19) United States
(12) Patent Application Publication
(10) Pub. No.: US 2017/0111882 A1
(43) Pub. Date: Apr. 20, 2017

(54) ELECTRONIC DEVICE AND NOTIFICATION CONTROL METHOD

(71) Applicant: Samsung Electronics Co., Ltd, Gyeonggi-do (KR)

(72) Inventors: Kwangmin Bang, Gyeonggi-do (KR); Changho Lee, Gyeonggi-do (KR)

(21) Appl. No.: 15/298,051

(22) Filed: Oct. 19, 2016

(30) Foreign Application Priority Data
Oct. 19, 2015 (KR) 10-2015-0145621

(51) Int. Cl. H04W 68/00; H04W 52/02

(52) U.S. Cl. CPC H04W 68/005; H04W 52/0254

(57) ABSTRACT

One or more embodiments provide a method and an electronic device capable of controlling notifications. A processor is configured to receive a first message from at least one external device via the communication circuit. The processor is configured to provide at least one notification, in a first mode via at least one user interface, in response to the reception of the first message. The processor is configured to detect the presence of at least one event related to the electronic device or the user of the electronic device. The processor is configured to receive a second message from at least one external device via the communication circuit. The processor is configured to provide at least one notification, in a second mode based on the received second message and at least one detected event, or in a first mode after a selected period of time has elapsed.

### CROSS-REFERENCE TO RELATED APPLICATION(S) AND CLAIM OF PRIORITY

The present application is related to and claims benefit under 35 U.S.C. §119(a) of Korean patent application filed on Oct. 19, 2015 in the Korean intellectual property office and assigned serial number 10-2015-0145621, the entire disclosure of which is hereby incorporated by reference.

### TECHNICAL FIELD

Various embodiments of the present disclosure relate to a method and an electronic device capable of controlling notifications.

### BACKGROUND

In recent years, the development of communication technology has led to the appearance of various types of handheld electronic devices, e.g., smartphones, tablet PCs, netbooks, wearable devices, and watch type terminals. Handheld electronic devices are capable of performing wireless communication with other electronic devices, e.g., a voice/video call, data communication exchanging text messages (e.g., short message service (SMS), long message service (LMS), and multimedia message service (MMS)), and mobile messengers (e.g., Facebook®, Twitter®, Line® and KakaoTalk®).

For example, when an electronic device receives a message via wireless communication, the electronic device is capable of providing the user with a push message notification service for notifying of the message reception. When the electronic device receives a push message, the electronic device turns on the display to show information regarding the message reception in a pop-up form, and also notifies of the message reception through a ring tone or a vibration. The handheld electronic device uses a push message notification service to notify the user of information regarding the reception of a message.

When an electronic device user is in a situation where the user cannot check the electronic device for a relatively long period of time, e.g., in a meeting or during business hours, repetition of message notification by a ring tone or a vibration causes disturbance and/or battery power consumption. When an electronic device user does not have his/her electronic device or is sleeping, the repetition of message notification by a ring tone or a vibration is pointless and consumes battery power. Therefore, to prevent the repetition of message notification via a ring tone or a vibration, individual applications may be set to corresponding notification modes, e.g., a mute notification mode.

However, when individual applications of an electronic device are set to a mute notification mode, this is disadvantageous in that the electronic device user may not check that is a message important for the user for a relatively long period time.

### SUMMARY

To address the above-discussed deficiencies, it is a primary object to provide a method which is capable of controlling the repetition of notification, thereby to reduce noise and the battery power consumption of the electronic device, according to the repetition of notification.

In accordance with an aspect of the present disclosure, an electronic device is provided. The electronic device includes: a communication circuit; at least one user interface; a processor electrically connected to the communication circuit and at least one user interface; and a memory electrically connected to the processor. The memory is configured to store instructions which enable the processor to: receive a first message from at least one external device via the communication circuit; provide at least one notification, in a first mode, via at least one user interface, in response to the reception of the first message; detect, after at least one notification has been provided in the first mode, the presence of at least one event related to the electronic device or the user of the electronic device; receive, after the presence of at least one event has been detected, a second message from at least one external device via the communication circuit; and provide at least one notification, in a second mode based on the received second message and at least one detected event, or in a first mode after a selected period of time has elapsed.

In accordance with another aspect of the present disclosure, a method of controlling the notification of a message in an electronic device is provided. The method includes recognizing, by a processor, the reception of a message from at least one external device. The method also includes determining, by the processor, whether the electronic device is in use. The method also includes, when the electronic device is in use, providing, by the processor, at least one notification, in a mode, via at least one user interface.

In accordance with another aspect of the present disclosure, a computer-readable recording medium storing a software program for controlling functions of an electronic device is provided, comprising instructions. The instructions enable the electronic device to receive a first message from at least one external device. The instructions enable the electronic device to provide at least one notification, in a first mode, via at least one user interface, in response to the reception of the first message. The instructions enable the electronic device to detect, after at least one notification has been provided in the first mode, the presence of at least one event related to the electronic device or the user of the electronic device; receive, after the presence of at least one event has been detected, a second message from at least one external device. The instructions enable the electronic device to provide at least one notification, in a second mode based on the received second message and at least one detected event, or in a first mode after a selected period of time has elapsed.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram showing a network environment including an electronic device according to various embodiments of the present disclosure;

FIG. 2 illustrates a block diagram of an electronic device according to various embodiments of the present disclosure;

FIG. 3 illustrates a block diagram of a program module according to various embodiments of the present disclosure;

FIG. 4 illustrates a diagram showing a system adapted to a notification control method and an electronic device according to various embodiments of the present disclosure;

FIG. 5 illustrates a block diagram of the configuration of an electronic device according to various embodiments of the present disclosure;

FIGS. 6A and 6B illustrate screens that show, when a number of messages arrive, a method of performing the notification control (mute alert) for the second message according to various embodiments of the present disclosure;

FIG. 7 illustrates a process that describes a message notification control method according to various embodiments of the present disclosure;

FIG. 8 illustrates a process that describes a message notification control method when the electronic device is connected to a cooperation device according to various embodiments of the present disclosure; and

FIG. 9 illustrates a process that describes a message notification control method when the electronic device is connected to an audio playback system according to various embodiments of the present disclosure.

### DETAILED DESCRIPTION

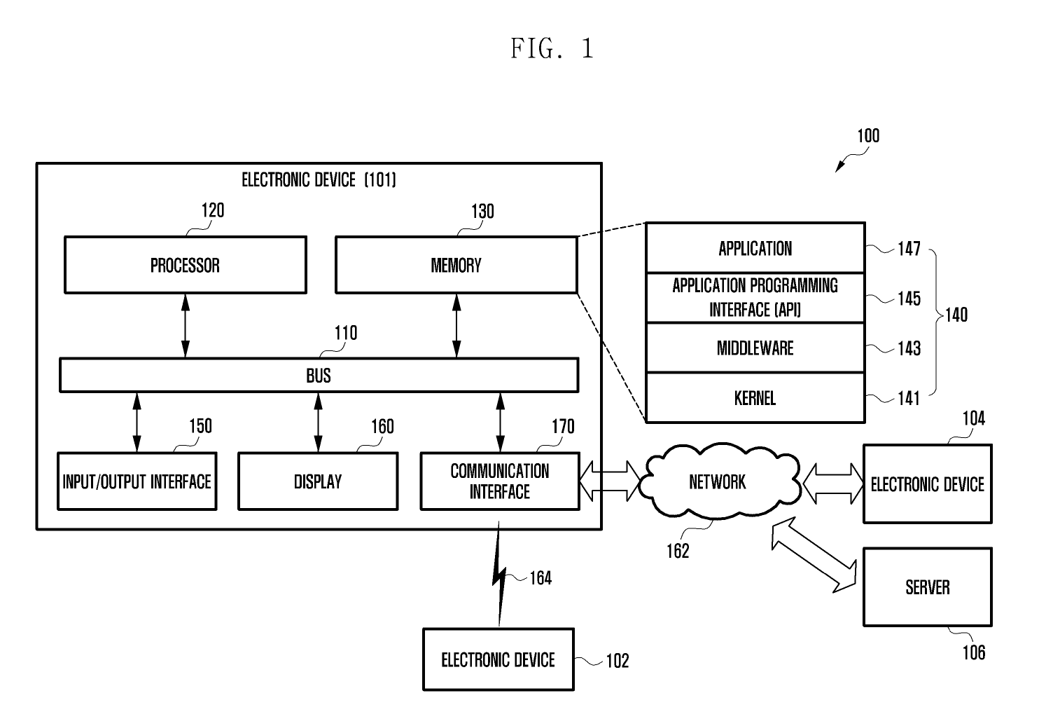

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device or method.

Hereinafter, the present disclosure will be described with reference to the accompanying drawings. Although specific embodiments are illustrated in the drawings and related detailed descriptions are discussed in the present specification, the present disclosure may have various modifications and several embodiments. However, various embodiments of the present disclosure are not limited to a specific implementation form and it should be understood that the present disclosure includes all changes and/or equivalents and substitutes included in the spirit and scope of various embodiments of the present disclosure. In connection with descriptions of the drawings, similar components are designated by the same reference numeral.

The term “include” or “may include” which may be used in describing various embodiments of the present disclosure refers to the existence of a corresponding disclosed function, operation or component which can be used in various embodiments of the present disclosure and does not limit one or more additional functions, operations, or components. In various embodiments of the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component is “coupled to” or “connected to” another component, the component may be directly coupled or connected to another component or a new component may exist between the component and another component. In contrast, when it is stated that a component is “directly coupled to” or “directly connected to” another component, a new component does not exist between the component and another component.

The terms used in describing various embodiments of the present disclosure are only examples for describing a specific embodiment but do not limit the various embodiments of the present disclosure. Singular forms are intended to include plural forms unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present description.

An electronic device according to various embodiments of the present disclosure may be a device including a projection function. For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HMD) such as electronic glasses, electronic clothes, and electronic bracelet, an electronic necklace, an electronic appcessary, an electronic tattoo, and a smart watch.

According to some embodiments, the electronic device may be a smart home appliance having a projection function. The smart home appliance may include at least one of a TeleVision (TV), a Digital Video Disk (DVD) player, an audio player, an air conditioner, a cleaner, an oven, a microwave oven, a washing machine, an air cleaner, a set-top box, a TV box (for example, Samsung® HomeSync™, Apple TV™, or Google TV™), game consoles, an electronic dictionary, an electronic key, a camcorder, and an electronic frame.

According to some embodiments, the electronic device may include at least one of various types of medical devices (for example, Magnetic Resonance Angiography (MRA), Magnetic Resonance Imaging (MRI), Computed Tomography (CT), a scanner, an ultrasonic device and the like), a navigation device, a Global Positioning System (GPS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM) of financial institutions, and a Point Of Sale (POS) device of shops.

According to some embodiments, the electronic device may include at least one of furniture or a part of a building/structure, an electronic board, an electronic signature receiving device, a projector, and various types of measuring devices (for example, a water meter, an electricity meter, a gas meter, a radio wave meter and the like) including a projection function. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above-described devices.

Hereinafter, an electronic device according to various embodiments of the present disclosure will be described with reference to the accompanying drawings. The term “user” used in various embodiments may refer to a person who uses an electronic device or a device (for example, an artificial intelligence electronic device) that uses an electronic device.

FIG. 1 illustrates a diagram showing a network environment 100 including an electronic device 101 according to various embodiments of the present disclosure.

Referring to FIG. 1, the electronic device 101 includes a bus 110, a processor 120, a memory 130, an input/output interface 150, a display 160 and a communication interface 170.

The bus 110 may be a circuit connecting the above-described components and transmitting communication (for example, a control message) between the above-described components.

The processor 120 receives commands from other components (for example, the memory 130, the input/output interface 140, the display 150, the communication interface 160, or the projecting management module 170) through the bus 110, analyzes the received commands, and executes calculation or data processing according to the analyzed commands.

The memory 130 stores commands or data received from the processor 120 or other components (for example, the input/output interface 150, the display 160 and the communication interface 170) or generated by the processor 120 or other components.

The memory 130 may include program 140, for example, a kernel 141, middleware 143, an Application Programming Interface (API) 145, and an application program 147. Each of the aforementioned programs may be implemented by software, firmware, hardware, or a combination of two or more thereof.

The kernel 141 controls or manages system resources (for example, the bus 110, the processor 120, or the memory 130) used for executing an operation or function implemented by the remaining other programming modules, for example, the middleware 143, the API 145, or the application program 147. Further, the kernel 141 provides an interface for accessing individual components of the electronic device 101 from the middleware 143, the API 145, or the application program 147 to control or manage the components.

The middleware 143 performs a relay function of allowing the API 145 or the application program 147 to communicate with the kernel 141 to exchange data. Further, in operation requests received from the application program 147, the middleware 143 performs a control for the operation requests (for example, scheduling or load balancing) by using a method of assigning a priority, by which system resources (for example, the bus 110, the processor 120, the memory 130 and the like) of the electronic device 101 can be used, to the application program 147.

The API 145 is an interface by which the application 147 can control a function provided by the kernel 141 or the middleware 143 and includes, for example, at least one interface or function (for example, command) for a file control, a window control, image processing, or a character control.

The input/output interface 150 transmits a command or data input from the user through an input/output device (for example, a sensor, a keyboard, or a touch screen) to the processor 120, the memory 130, the communication interface 170 through, for example, the bus 110. For example, the input/output interface 150 may provide data on a user's touch input through a touch screen to the processor 120.

The display 160 displays various pieces of information (for example, multimedia data, text data, or the like) for the user. According to an embodiment, the display 160 may display a graphic user interface image for interaction between the user and the electronic device 101. According to various embodiments, the graphic user interface image may include interface information to activate a function for correcting color of the image to be projected onto the screen. The interface information may be in the form of, for example, a button, a menu, or an icon.

The communication interface 170 connects communication between the electronic device 101 and the external device (for example, electronic device 104 or server 106). For example, the communication interface 170 may access a network 162 through wireless or wired communication to communicate with the external device. The wireless communication includes at least one of, for example, WiFi, BlueTooth (BT), Near Field Communication (NFC), a Global Positioning System (GPS), and cellular communication (for example, LTE, LTE-A, CDMA, WCDMA, UMTS, WiBro or GSM). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the network 162 may be a telecommunication network. The telecommunication network includes at least one of a computer network, Internet, Internet of things, and a telephone network. According to an embodiment, a protocol (for example, transport layer protocol, data link layer protocol, or physical layer protocol) for communication between the electronic device 101 and the external device may be supported by at least one of the application program 147, the application programming interface 145, the middleware 143, the kernel 141, and the communication interface 170.

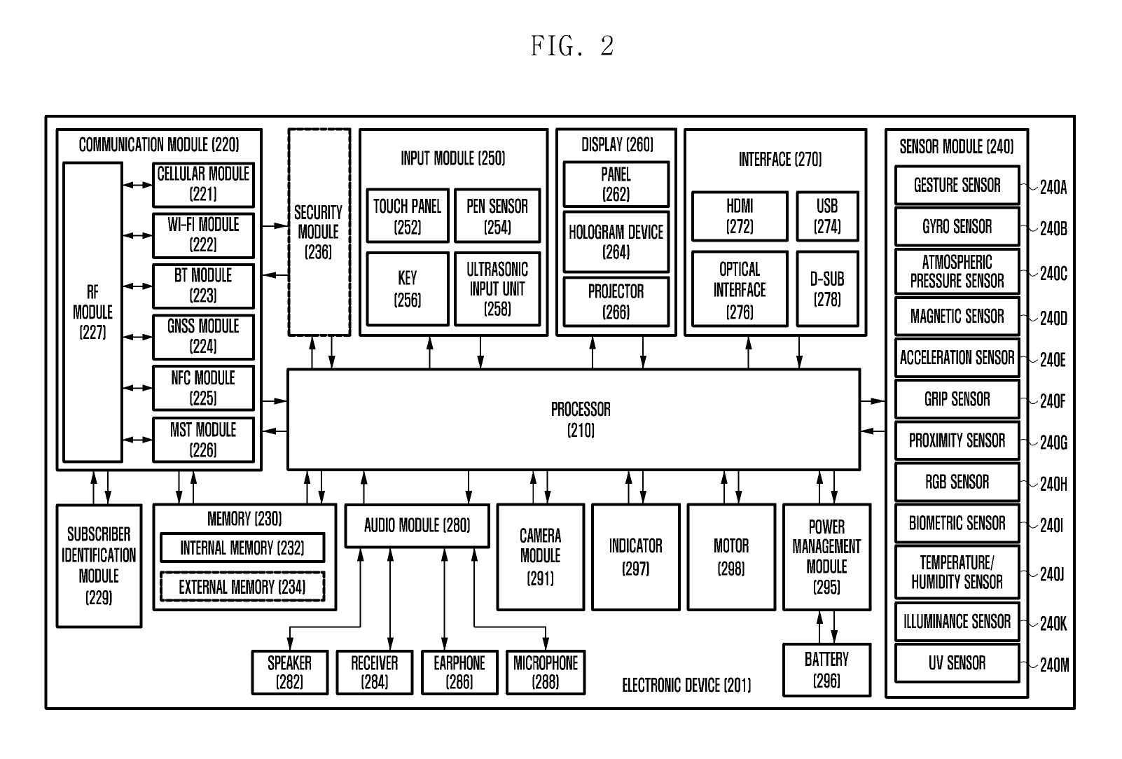

FIG. 2 illustrates a block diagram of an electronic device 201 according to various embodiments of the present disclosure.

The electronic device 201 may configure, for example, a whole or a part of the electronic device 101 illustrated in FIG. 1. Referring to FIG. 2, the electronic device 201 includes one or more Processor 210, a communication module 220, a Subscriber Identification Module (SIM) card 229, a memory 230, a sensor module 240, an input device 250, a display 260, an interface 270, an audio module 280, a camera module 291, a power managing module 295, a battery 296, an indicator 297, and a motor 298.

The processor 210 operates an operating system (OS) or an application program so as to control a plurality of hardware or software component elements connected to the processor 210 and execute various data processing and calculations including multimedia data. The processor 210 may be implemented by, for example, a System on Chip (SoC). According to an embodiment, the processor 210 may further include a Graphic Processing Unit (GPU).

The communication module 220 (for example, communication interface 170) transmits/receives data in communication between different electronic devices (for example, the electronic device 104 and the server 106) connected to the electronic device 201 (for example, electronic device 101) through a network. According to an embodiment, the communication module 220 includes a cellular module 221, a WiFi module 222, a BlueTooth (BT) module 223, a Global Positioning System (GPS) module 224, a Near Field Communication (NFC) module 225, and a Radio Frequency (RF) module 226.

The cellular module 221 provides a voice, a call, a video call, a Short Message Service (SMS), or an Internet service through a communication network (for example, Long Term Evolution (LTE), LTE-A, Code Division Multiple Access (CDMA), Wideband CDMA (WCDMA), UMTS, WiBro, GSM or the like). Further, the cellular module 221 may distinguish and authenticate electronic devices within a communication network by using a subscriber identification module (for example, the SIM card 229). According to an embodiment, the cellular module 221 performs at least some of the functions that can be provided by the processor 210. For example, the cellular module 221 may perform at least some of the multimedia control functions.

According to an embodiment, the cellular module 221 may include a Communication Processor (CP). Further, the cellular module 221 may be implemented by, for example, a SoC. Although the components such as the cellular module 221 (for example, communication processor), the memory 230, and the power managing module 295 are illustrated as components separate from the processor 210 in FIG. 2, the processor 210 may include at least some (for example, cellular module 221) of the aforementioned components in an embodiment.

According to an embodiment, the processor 210 or the cellular module 221 (for example, communication processor) may load a command or data received from at least one of a non-volatile memory and other components connected to each of the processor 210 and the cellular module 221 to a volatile memory and process the loaded command or data. Further, the processor 210 or the cellular module 221 may store data received from at least one of other components or generated by at least one of other components in a non-volatile memory.

Each of the WiFi module 222, the BT module 223, the GPS module 224, and the NFC module 225 may include, for example, a processor for processing data transmitted/received through the corresponding module. Although the cellular module 221, the WiFi module 222, the BT module 223, the GPS module 224, and the NFC module 225 are illustrated as blocks separate from each other in FIG. 2, at least some (for example, two or more) of the cellular module 221, the WiFi module 222, the BT module 223, the GPS module 224, and the NFC module 225 may be included in one Integrated Chip (IC) or one IC package according to one embodiment. For example, at least some (for example, the communication processor corresponding to the cellular module 221 and the WiFi processor corresponding to the WiFi module 222) of the processors corresponding to the cellular module 221, the WiFi module 222, the BT module 223, the GPS module 224, and the NFC module 225 may be implemented by one SoC.

The RF module 227 transmits/receives data, for example, an RF signal. Although not illustrated, the RF module 227 may include, for example, a transceiver, a Power Amp Module (PAM), a frequency filter, a Low Noise Amplifier (LNA) or the like. Further, the RF module 227 may further include a component for transmitting/receiving electronic waves over a free air space in wireless communication, for example, a conductor, a conducting wire, or the like. Although the cellular module 221, the WiFi module 222, the BT module 223, the GPS module 224, and the NFC module 225 share one RF module 227 in FIG. 2, at least one of the cellular module 221, the WiFi module 222, the BT module 223, the GPS module 224, and the NFC module 225 may transmit/receive an RF signal through a separate RF module according to one embodiment.

The SIM card 229 is a card including a Subscriber Identification Module and may be inserted into a slot formed in a particular portion of the electronic device. The SIM card 229 includes unique identification information (for example, Integrated Circuit Card IDentifier (ICCID)) or subscriber information (for example, International Mobile Subscriber Identity (IMSI).

The memory 230 (for example, memory 130) may include an internal memory 232 or an external memory 234. The internal memory 232 may include, for example, at least one of a volatile memory (for example, a Random Access Memory (RAM), a dynamic RAM (DRAM), a static RAM (SRAM), a synchronous dynamic RAM (SDRAM), and the like), and a non-volatile Memory (for example, a Read Only Memory (ROM), a one time programmable ROM (OTPROM), a programmable ROM (PROM), an erasable and programmable ROM (EPROM), an electrically erasable and programmable ROM (EEPROM), a mask ROM, a flash ROM, a NAND flash memory, an NOR flash memory, and the like).

According to an embodiment, the internal memory 232 may be a Solid State Drive (SSD). The external memory 234 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 234 may be functionally connected to the electronic device 201 through various interfaces. According to an embodiment, the electronic device 201 may further include a storage device (or storage medium) such as a hard drive.

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor 240H (for example, Red, Green, and Blue (RGB) sensor) 240H, a biometric sensor 240I, a temperature/humidity sensor 240J, an illumination (light) sensor 240K, and a Ultra Violet (UV) sensor 240M. Additionally or alternatively, the sensor module 240 may include, for example, a E-nose sensor, an electromyography (EMG) sensor, an electroencephalogram (EEG) sensor, an electrocardiogram (ECG) sensor, an InfraRed (IR) sensor, an iris sensor, a fingerprint sensor (not illustrated), and the like. The sensor module 240 may further include a control circuit for controlling one or more sensors included in the sensor module 240.

The input device 250 includes a touch panel 252, a (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 can recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a keypad. The ultrasonic input device 258 is a device that can detect an acoustic wave by a microphone (for example, microphone 288) of the electronic device 201 through an input means generating an ultrasonic signal to identify data and can perform wireless recognition. According to an embodiment, the electronic device 201 receives a user input from an external device (for example, computer or server) connected to the electronic device 201 by using the communication module 220.

The display 260 (for example, display 160) includes a panel 262, a hologram device 264, and a projector 266. The panel 262 may be, for example, a Liquid Crystal Display (LCD) or an Active Matrix Organic Light Emitting Diode (AM-OLED). The panel 262 may be implemented to be, for example, flexible, transparent, or wearable. The touch panel 252 and one module may configure the panel 262. The hologram device 264 shows a stereoscopic image in the air by using interference of light. The projector 266 projects light on a screen to display an image. For example, the screen may be located inside or outside the electronic device 201. According to an embodiment, the display 260 may further include a control circuit for controlling the panel 262, the hologram device 264, and the projector 296.

The interface 270 includes, for example, a High-Definition Multimedia Interface (HDMI) 272, a Universal Serial Bus (USB) 274, an optical interface 276, and a D-subminiature (D-sub) 278. The interface 270 may be included in, for example, the communication interface 170 illustrated in FIG. 1. Additionally or alternatively, the interface 290 may include, for example, a Mobile High-definition Link (MHL) interface, a Secure Digital (SD) card/Multi-Media Card (MMC), or an Infrared Data Association (IrDA) standard interface.

The audio module 280 bi-directionally converts a sound and an electronic signal. At least some components of the audio module 280 may be included in, for example, the input/output interface 150 illustrated in FIG. 1. The audio module 280 processes sound information input or output through, for example, a speaker 282, a receiver 284, an earphone 286, the microphone 288 or the like.

The camera module 291 is a device that can photograph a still image and a video. According to an embodiment, the camera module 291 may include one or more image sensors (for example, a front sensor or a back sensor), an Image Signal Processor (ISP) (not shown) or a flash (for example, an LED or xenon lamp).

The power managing module 295 manages power of the electronic device 201. Although not illustrated, the power managing module 295 may include, for example, a Power Management Integrated Circuit (PMIC), a charger Integrated Circuit (IC), or a battery or fuel gauge.

The PMIC may be mounted to, for example, an integrated circuit or a SoC semiconductor. A charging method may be divided into wired and wireless methods. The charger IC charges a battery and prevent over voltage or over current from flowing from a charger. According to an embodiment, the charger IC includes a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier or the like may be added.

The battery fuel gauge measures, for example, a remaining quantity of the battery 296, or a voltage, a current, or a temperature during charging. The battery 296 may store or generate electricity and supply power to the electronic device 201 by using the stored or generated electricity. The battery 296 may include a rechargeable battery or a solar battery.

The indicator 297 shows particular statuses of the electronic device 201 or a part (for example, processor 210) of the electronic device 201, for example, a booting status, a message status, a charging status and the like.

The motor 298 converts an electrical signal to a mechanical vibration. Although not illustrated, the electronic device 201 may include a processing unit (for example, GPU) for supporting a module TV. The processing unit for supporting the mobile TV may process, for example, media data according to a standard of Digital Multimedia Broadcasting (DMB), Digital Video Broadcasting (DVB), media flow or the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, a few of the components may be omitted, or additional components may be further included. Also, some of the components of the electronic device according to various embodiments of the present disclosure may be combined to form a single entity, and thus may equivalently execute functions of the corresponding components before being combined.

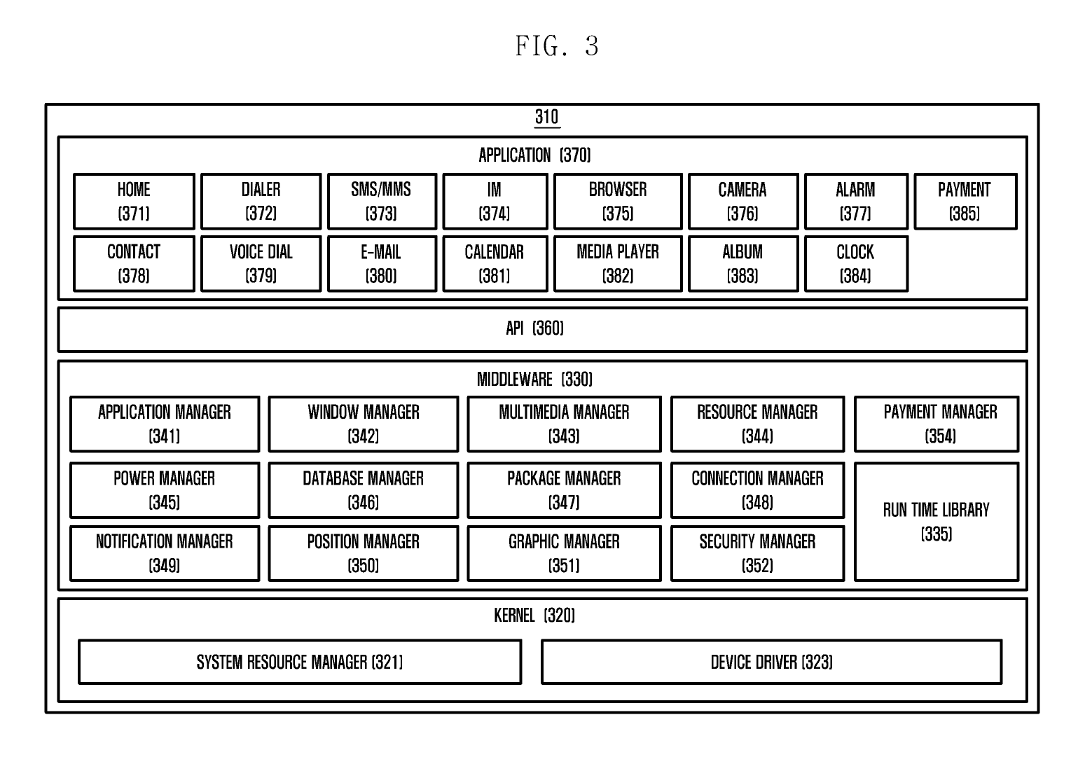

FIG. 3 illustrates a block diagram of a programming module according to various embodiments. According to an embodiment, the program module 310 (e.g., program module 140 shown in FIG. 1) is capable of including an operation system (OS) for controlling resources related to the electronic device (e.g., electronic device 101) and/or various applications (e.g., application programs 147 shown in FIG. 1) running on the OS. The OS may be Android®, iOS®, Windows®, Symbian®, Tizen®, Bada®, and the like.

The program module 310 is capable of including a kernel 320, middleware 330, application programming interface (API) 360 and/or applications 370. At least part of the program module 310 may be preloaded on the electronic device or downloaded from a server (e.g., an electronic device 102 or 104, server 106, and the like).

The kernel 320 (for example, kernel 141) may include a system resource manager 321 and/or a device driver 323. The system resource manager 321 may include, for example, a process manager, a memory manager, and a file system manager. The system resource manager 321 may perform a system resource control, allocation, and recall. The device driver 323 may include, for example, a display driver, a camera driver, a Bluetooth driver, a shared memory driver, a USB driver, a keypad driver, a WiFi driver, and an audio driver. Further, according to an embodiment, the device driver 323 may include an Inter-Process Communication (IPC) driver.

The middleware 330 may provide a function used in common by the applications 370. Further, the middleware 330 may provide a function through the API 360 to allow the applications 370 to efficiently use limited system resources within the electronic device. According to an embodiment, the middleware 330 (for example, the middleware 143) may include at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352.

The runtime library 335 may include, for example, a library module used by a complier to add a new function through a programming language while the applications 370 are executed. According to an embodiment, the runtime library 335 executes input and output, management of a memory, a function associated with an arithmetic function and the like.

The application manager 341 may manage, for example, a life cycle of at least one of the applications 370. The window manager 342 may manage GUI resources used on the screen. The multimedia manager 343 may detect a format used for reproducing various media files and perform an encoding or a decoding of a media file by using a codec suitable for the corresponding format. The resource manager 344 manages resources such as a source code, a memory, or a storage space of at least one of the applications 370.

The power manager 345 may operate together with a Basic Input/Output System (BIOS) to manage a battery or power and provides power information used for the operation. The database manager 346 may manage generation, search, and change of a database to be used by at least one of the applications 370. The package manager 347 may manage an installation or an update of an application distributed in a form of a package file.

The connection manager 348 may manage, for example, a wireless connection such as WiFi or Bluetooth. The notification manager 349 may display or notify a user of an event such as an arrival message, an appointment, a proximity alarm or the like, in a manner that does not disturb the user. The location manager 350 may manage location information of the electronic device. The graphic manager 351 may manage a graphic effect provided to the user or a user interface related to the graphic effect. The security manager 352 provides a general security function used for a system security or a user authentication. According to an embodiment, when the electronic device (for example, the electronic device 101) has a call function, the middleware 330 may further include a telephony manager for managing a voice of the electronic device or a video call function.

The middleware 330 is capable of including modules configuring various combinations of functions of the above-described components. The middleware 330 is capable of providing modules specialized according to types of operation systems to provide distinct functions. The middleware 330 may be adaptively configured in such a way as to remove part of the existing components or to include new components.

The API 360 (for example, API 145) may be a set of API programming functions, and may be provided with a different configuration according to an operating system. For example, in Android or iOS, a single API set may be provided for each platform. In Tizen, two or more API sets may be provided.

The applications 370 (e.g., application programs 147) may include one or more applications for performing various functions, e.g., home 371, diary 372, SMS/MMS 373, instant message (IM) 374, browser 375, camera 376, alarm 377, contact 378, voice dial 379, email 380, calendar 381, media player 382, album 383, clock 384, health care (e.g., an application for measuring amount of exercise, blood sugar level, and the like), and environment information (e.g., an application for providing atmospheric pressure, humidity, temperature, and the like).

According to an embodiment, the applications 370 are capable of including an application for supporting information exchange between an electronic device (e.g., electronic device 101) and an external device (e.g., electronic devices 102 and 104), which is hereafter called ‘information exchange application’). The information exchange application is capable of including a notification relay application for relaying specific information to external devices or a device management application for managing external devices.

For example, the notification relay application is capable of including a function for relaying notification information, created in other applications of the electronic device (e.g., SMS/MMS application, email application, health care application, environment information application, and the like) to external devices (e.g., electronic devices 102 and 104). In addition, the notification relay application is capable of receiving notification information from external devices to provide the received information to the user.

The device management application is capable of managing (e.g., installing, removing or updating) at least one function of an external device (e.g., electronic devices 102 and 104) communicating with the electronic device. Examples of the function are a function of turning-on/off the external device or part of the external device, a function of controlling the brightness (or resolution) of the display, applications running on the external device, services provided by the external device, and the like. Examples of the services are a call service, messaging service, and the like.

According to an embodiment, the applications 370 are capable of including an application (e.g., a health care application of a mobile medical device, and the like) specified attributes of an external device (e.g., electronic devices 102 and 104). According to an embodiment, the applications 370 are capable of including applications received from an external device (e.g., a server 106, electronic devices 102 and 104). According to an embodiment, the applications 370 are capable of including a preloaded application or third party applications that can be downloaded from a server. It should be understood that the components of the program module 310 may be called different names according to types of operating systems.

According to various embodiments, at least part of the program module 310 can be implemented with software, firmware, hardware, or any combination of two or more of them. At least part of the program module 310 can be implemented (e.g., executed) by a processor (e.g., processor 210). At least part of the programming module 310 may include modules, programs, routines, sets of instructions or processes, and the like, to perform one or more functions.

The term “module” used in the present disclosure may refer to, for example, a unit including at least one combination of hardware, software, and firmware. The “module” may be interchangeably used with a term, such as unit, logic, logical block, component, and/or circuit. The “module” may be a minimum unit of an integrally configured article and/or a part thereof. The “module” may be a minimum unit performing at least one function and/or a part thereof. The “module” may be mechanically and/or electronically implemented. For example, the “module” according to the present disclosure may include at least one of an Application-Specific ICt (ASIC) chip, a Field-Programmable Gate Arrays (FPGA), and a programmable-logic device for performing operations that are known and/or are to be developed hereinafter.

According to various embodiments, at least some of the devices (for example, modules or functions thereof) or the method (for example, operations) according to the present disclosure may be implemented by a command stored in a computer-readable storage medium in a programming module form. When the instructions are executed by at least one processor (e.g., the processor 120), the at least one processor may perform functions corresponding to the instructions. The computer-readable storage medium may be, for example, the memory 130. At least a part of the programming module may be implemented (for example, executed) by, for example, the processor 120. At least some of the programming modules may include, for example, a module, a program, a routine, a set of instructions or a process for performing one or more functions.

The computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, the program instructions may include high class language codes, which can be executed in a computer by using an interpreter, as well as machine codes made by a compiler. The aforementioned hardware device may be configured to operate as one or more software modules to perform the operation of the present disclosure, and vice versa.

The module or programming module of the present disclosure may include at least one of the aforementioned components with omission of some components or addition of other components. The operations of the modules, programming modules, or other components may be executed in series, in parallel, recursively, or heuristically. Also, some operations may be executed in different order, omitted, or extended with other operations.

In various embodiments of the present disclosure, the term “normal alert” refers to an example where, when a push message arrives, the electronic device notifies the arrival of the push message in such a way that it turns on the display to provide an illumination effect, such as a blinking, and outputs a ring tone or a vibration.

The term “notification control” or “mute alert” refers to an example where, when a push message arrives, since the electronic device has made the first normal alert for the arrival of the push message, the electronic device prevents the display of the repetition of message arrival notification from being turned on, so as not to provide a blinking effect, and processes a ring tone or a vibration in mute mode.

In various embodiments of the present disclosure, the electronic device 400, the cooperation device 402 and at least one external device 406 are each capable of including at least one of the following: a mobile phone, a smartphone, a tablet PC, a handheld PC, a Portable Multimedia Player (PMP), a Personal Digital Assistant (PDA), a wearable terminal, a watch type terminal, and an audio playback system.

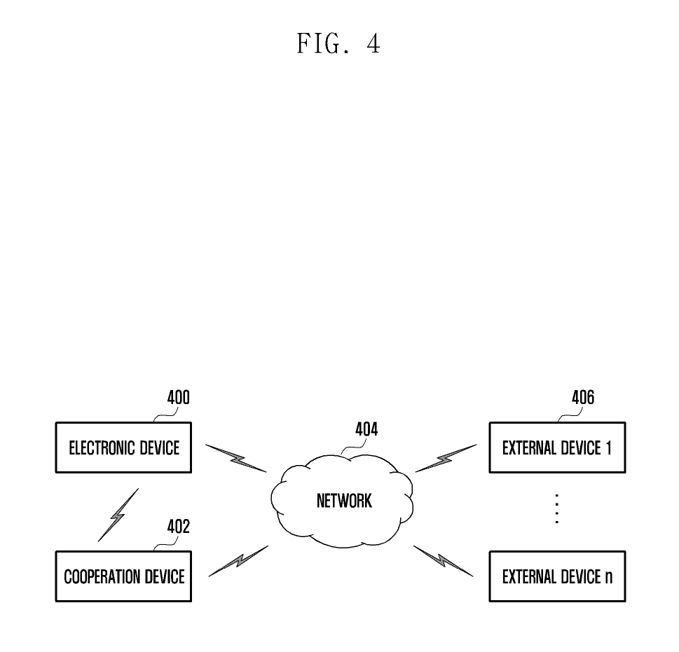

FIG. 4 illustrates a diagram showing a system adapted to a notification control method and an electronic device according to various embodiments of the present disclosure.

Referring to FIG. 4, the system is capable of including an electronic device 400, a cooperation device 402, a network 404 and an external device 406.

The electronic device 400 is capable of transmitting/receiving data to/from other electronic devices, for example, calls, text messages, mobile messengers, and the like.

The electronic device 400 is capable of transmitting/receiving messages to/from at least one external device 406. The electronic device 400 may set at least one of the following: a normal alert, notification control (mute alert), a notification control time, the number of notification control, and a reminder notification.

The cooperation device 402 is capable of including at least one of the following: a wearable terminal, a watch type terminal and an audio playback system which are cooperating with each other, based on the electronic device 400 serving as a main terminal. The cooperation device 402 is capable of exchanging information with the electronic device 400 via the network 404 or via short-range communication.

The network 404 is capable of supporting wireless/wired communication between the electronic device 400, the cooperation device 402 and the external device 406. Examples of the network 404 are a telecommunication network, a computer network (e.g., LAN or WAN), the Internet, and a telephone network.

The external device 406 is capable of transmitting/receiving data to/from the electronic device 400 or the cooperation device 402. For example, the external device 406 may be configured to include a number of electronic devices, external device 1—external device n (wherein n is positive integers), which are used by other users except for the user who uses the electronic device 400.

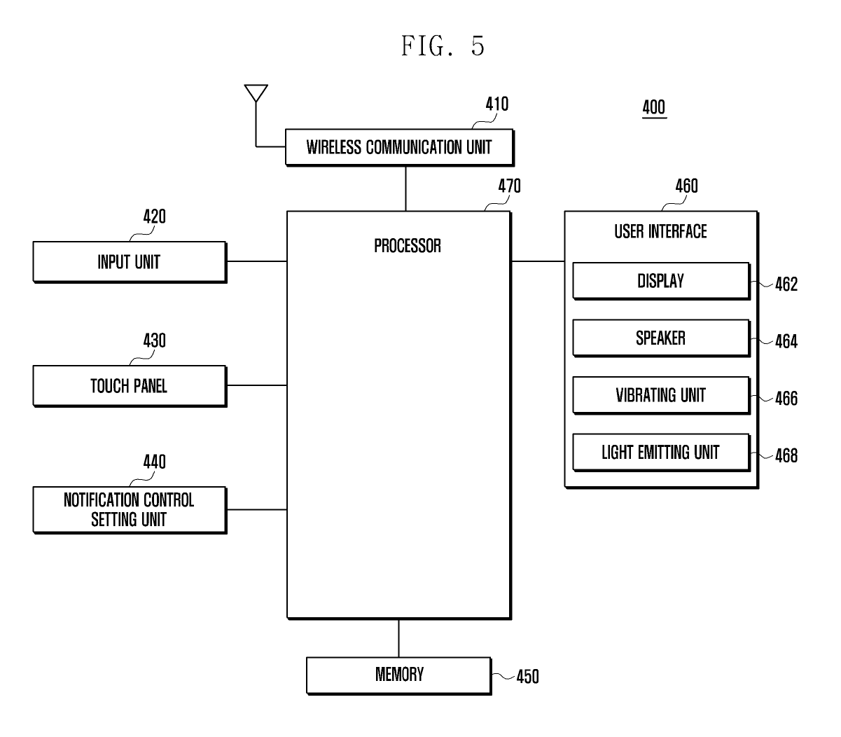

FIG. 5 illustrates a block diagram of the configuration of an electronic device according to various embodiments of the present disclosure.

Referring to FIG. 5, the electronic device 400 is capable of including a wireless communication unit 410, an input unit 420, a touch panel 430, a notification control setting unit 440, a memory 450, a user interface 460 and a processor 470.

In an embodiment, the wireless communication unit 410 is capable of performing a communication function for the electronic device 400. The wireless communication unit 410 is capable of establishing a communication channel with the network 404 and performing communication functions, such as voice or video call/communication, data communication, and the like, with at least one external device 406. The wireless communication unit 410 is capable of including mobile communication modules (e.g., at least one module for supporting various types of communication modes, such as 2G, 3G, 4G, and the like), a Wi-Fi module, an NFC module, and the like. The wireless communication unit 410 is capable of including an RF transmitter for up-converting the frequency of signals to be transmitted and amplifying the signals and an RF receiver for low-noise amplifying received RF signals and down-converting the frequency of the received RF signals. The wireless communication unit 410 is capable of receiving data via a wireless channel and transferring the data to the processor 470. The wireless communication unit 410 is capable of receiving data output from the processor 470 and transmitting the data to the external device 406 via the network 404.

In various embodiments, the wireless communication unit 410 may be a communication circuit which is capable of performing a communication function, such as the transmission/reception of one or more messages to/from at least one external device 406.

The input unit 420 is capable of creating various input signals used for operations of the terminal. The input unit 420 is capable of receiving a user's settings and a user's inputs for controlling the electronic device 400, creating input signals, and transferring the created signals to the processor 470. The processor 470 is capable of controlling functions corresponding to the input signals. The input unit 420 may be implemented with a keypad including numeric keys and direction keys. The electronic device 400 may include function keys on one side.

The touch panel 430 may include a touch sensor or a pressure sensor, e.g., a capacitive overlay sensor, a resistive overlay sensor, an infrared beam sensor, and the like. It should be understood that the embodiments of this disclosure are not limited to the sensors listed above. That is, the touch panel 430 can be implemented with all types of sensors when the sensors can sense touch, contact, proximity, pressure, and the like.

The touch panel 430 is capable of sensing a user's touch inputs. For example, when a user's finger or a touch input tool such as a stylus and the like. contacts or is close to the touch panel 430, the touch panel 430 generates the touch event and transfers a signal corresponding to the generated touch event to the processor 470. For example, the touch panel 430 is capable of sensing the change in physical quantity (e.g., capacitance, resistance, and the like) according to the contact or proximity by a touch input tool, thereby recognizing the presence of a touch event. The touch panel 430 may be implemented with an electromagnetic induction type touch panel for detecting a stylus pen of an electromagnetic induction type.

In various embodiments, the touch panel 430 is capable of providing functions that enable the electronic device 400 to check messages received from at least one external device 406. The touch panel 430 allows the user to select a function such that the electronic device 400 can perform a normal alert or notification control (mute alert) for messages received from the external device 406.

In various embodiments, when the electronic device 400 receives a message from at least one external device 406, after the notification control setting unit 440 performs the first normal alert of the received message, the notification control setting unit 440 may set the notification control (mute control, mute alert) for a notification that additionally occurs within a preset time interval (e.g., 2-5 minutes), so as not to turn on the display or generate a ring tone or a vibration. When a message arrives in a situation where the user of the electronic device 400 cannot check the electronic device 400 for a relatively long period of time, e.g., when the user does not have the electronic device 400, during sleeping, and the like, the notification control setting unit 440 may be set in such a way that notification control setting unit 440 performs the first normal alert of the message arrival, and then increases the notification control time interval or reduce or reduces the number of notifications of the message arrival.

In an embodiment, when the electronic device 400 connects with/to at least one cooperation device 402, the notification control setting unit 440 may be set in such a way that a notification cannot be generated in duplicate in the cooperation devices. The notification control setting unit 440 may be set to perform a normal notification when the electronic device 400 is in use.

In an embodiment, the notification control setting unit 440 may be set in such a way as to provide, when the electronic device 400 receives a message from at least one external device 406, a reminder notification (turning on the display or generating a ring tone or a vibration) one or more times within a preset period of time (e.g., 20˜50 minutes) to prevent a situation where the user may forget the arrival notification of a particular or important message, which is because the notification is set in such a way that the display is not turned on or a ring tone or a vibration operates in mute mode since the first normal alert (e.g., a sound, a vibration) of the arrival of the message has been made. The notification control setting unit 440 may set, since the first normal alert has been made, a period of time of reminder notification (e.g., 20˜50 minutes), a repeating interval of reminder notification interval (e.g., 2˜5 minutes), the number of repeated reminder notifications (e.g., 20-30 times). For example, the notification control setting unit 440 may set in such a way as to increase a period of time of reminder notification for a received message and decrease the repeated number of reminder notifications.

The memory 450 is capable of storing programs for the processor 470 to perform processing or controlling functions, an Operating System (OS), various applications, and functions for performing the input/output of data. The memory 450 is also capable of storing programs for controlling operations of the electronic device 400. The memory 450 is capable of storing: various settings used to process functions in the electronic device 400; and user interface (UI) provided by the electronic device 400.

In various embodiments, the memory 450 is capable of storing a program for supporting functions related to the normal alert or the notification control (mute alert). The program for supporting a notification function may include information for setting functions for displaying a screen for notifying the arrival of a message, generating a ring tone or a vibration, and outputting a blinking effect. The memory 450 is capable of storing settings set up via the notification control setting unit 440. The processor 470 is capable of executing the electronic device based on the settings stored in the memory 450.

For example, the memory 450 is capable of storing instructions (commands) therein. The instructions enable the processor 470 to: receive a first message from at least one external device 406 via the wireless communication unit 410; and provide at least one notification in a first mode via at least one user interface 460, in response to the reception of the first message. After providing at least one notification in a first mode, the instructions enable the processor 470 to detect at least one event (e.g., setup information) related to the electronic device 400 and/or the user of the electronic device 400. After detecting at least one event, the instructions enable the processor 470 to receive a second message from at least one external device 406 via the wireless communication unit 410. The instructions enable the processor 470 to provide at least one notification: in a second mode, based on the second message and at least one event; or in a first mode after a selected period of time (e.g., a setup time) has elapsed.

The event (e.g., setup information) may include an example where selected information (set information) is obtained from an ambient environment (e.g., notification control setting unit 440) of the electronic device 400 and an example where an input for at least one user interface 460 has not been received during a selected period of time (a set period of time).

The user interface 460 is capable of including a display 462, a speaker 464, a vibrating unit 466 and a light-emitting unit 468 which will be described later. The user interface 460 is also capable of including the input unit 420 and the touch panel 430.

The first mode includes a mode where at least one notification is provided in a first measure. An example of the first mode is a mode where, when a message arrives in the electronic device 400, the electronic device 400 turns off the display and/or generates a ring tone or a vibration to perform a normal alert of the arrival of the message.

The second mode includes a mode where at least one notification is provided in a second measure that differs from the first measure. An example of the second mode is a mode where, when a message arrives in the electronic device 400, since the first normal alert of the arrival of the message, the electronic device prevents the display for the repeated notifications of the arrival of the message from being turned on and processes a ring tone or a vibration in notification control (mute alert) mode.

The instructions (commands) enable the processor 470 to obtain situation information related to the electronic device 400 and/or the user of the electronic device 400 and detect the presence of at least one event based on the obtained situation information.

The situation information related to the electronic device 400 and/or the user of the electronic device 400 may contain a situation where the electronic device 400 has not been used for a relatively long period of time, a situation where the electronic device 400 is connected to a number of cooperation devices, a situation where the electronic device 400 is in use, and the like.

The user interface 460 is capable of transferring commands or data, received from the user of the electronic device 400 or from other external device 406, to the components of the electronic device 400. The user interface 460 is capable of outputting commands or data, received from the components of the electronic device 400, to the user or another external device 406.

In various embodiments, the user interface 460 is capable of outputting messages received from at least one external device 406 to the outside. The user interface 460 is capable of including a display 462, a speaker 464, a vibrating unit 466 and a light-emitting unit 468.

The display 462 is capable of visually providing the user with various types of information regarding the electronic device 400, such as operation states, menus, input data, function setup information, and the like. The display 462 may be implemented with a Liquid Crystal Display (LCD), Organic Light Emitting Diode (OLED), Active Matrix Organic Light Emitting Diode (AM-OLED), Flexible Display, a transparent display, and the like.

When the electronic device receives a message from at least one external device 406, the display 462 is capable of providing a visual feedback screen. The display 462 is capable of outputting a message reception notification screen, a message content display screen, and the like, under the control of the processor 470. The display 462 is capable of providing a message reception notification screen, in a pop-up form, overlapping another execution screen, or in a full screen form. The display 462 is capable of outputting a message reception notification on a part of the display, e.g., the top, the bottom, or the center of the screen.

The speaker 464 is capable of including an audio codec that processes audio signals created or decoded in the electronic device 400 and outputs audible sounds. The speaker 464 is capable of performing the conversion between sounds and electrical signals. For example, the speaker 464 is capable of processing audio signals input/output via a receiver, earphones, a microphone, and the like.

In a state where a message notification function of the electronic device 400 has been set in a sound mode, when a message arrives from at least one external device 406, the speaker 464 is capable of outputting an audio sound effect such as a ring tone or a notification sound.

The vibrating unit 466 is capable of including a stepping motor (shaft-less vibration motor) for causing the vibration of the electronic device 400. When the electronic device receives a message from at least one external device 406, the vibrating unit 466 generates the vibration in the electronic device 400 under the control of the processor 470. For example, in a state where the message notification function of the electronic device 400 is set to a vibrate mode, when a message arrives, the electronic device 400 executes the vibration feedback of the vibrating unit 466, thereby notifying the user of the arrival of a message.

In an embodiment, when the electronic device receives a message from at least one external device 406, the light-emitting unit 468 is capable of providing the display 462 with an illumination effect, such as blinking of a message icon shaped as a postcard.

Although the embodiment is implemented in such a way that the user interface 460 includes a display 462, a speaker 464, a vibrating unit 466 and a light-emitting unit 468, it should be understood that the user interface 460 may be configured to include the input unit 420 and the touch panel 430 for controlling the input or the operation of the electronic device 400.

The processor 470 is capable of controlling operations of the electronic device 400 and signal flows among the components in electronic device 400. The processor 470 is also capable of processing data in the electronic device 400. The processor 470 is capable of including a central processing unit (CPU), an application processor (AP), a communication processor (CP), and the like. The processor 470 may be implemented with a single core processor or a multi-core processor. The processor 470 may also be implemented with a number of processors.

In various embodiments, the processor 470 is capable of controlling operations and signal flow among the components of the electronic device 400, e.g., the wireless communication unit 410, the input unit 420, the touch panel 430, the notification control setting unit 440, the memory 450 and the user interface 460. When a message arrives from at least one external device 406, the processor 470 is capable of determining whether, since the first notification of the arrival of a message has been made, the notification of the message arrival is meaninglessly repeated in various situations, such as a notification when the electronic device has not been used for a relatively long period of time, a duplicate notification to a number of cooperation devices, a notification while the electronic device is in use, and the like; and controlling the notification based on the determination.

In various embodiments, the processor 470 is capable of executing or controlling instructions (commands). According to the instructions, the processor 470 receives a first message from at least one external device 406 via the wireless communication unit 410 and provides at least one notification in a first mode (a normal alert) via at least one user interface 460, in response to the reception of the first message. After providing at least one notification in a first mode (a normal alert), the processor 470 detects at least one event (e.g., setup information regarding a normal alert or a notification control (mute alert)) related to the electronic device 400 and/or the user of the electronic device 400. After detecting at least one event, the processor 470 receives a second message from at least one external device 406 via the wireless communication unit 410. The processor 470 provides at least one notification: in a second mode (notification control (mute alert)), based on the second message and at least one event; or in a first mode (normal alert) after a selected period of time (e.g., a setup time for notification control (mute alert)) has elapsed.

In various embodiments, with the convergence of digital devices, the electronic device 400 may have various modifications. The electronic device 400 may further include other components not listed above, e.g., various types of sensor modules for detecting information related to the change of position, a GPS module for measuring a location of the electronic device 400, and the like. The electronic device 400 may also be implemented in such a way that at least one of the components is replaced with other elements. For example, the input unit 420 may be implemented with a touchscreen, a key input unit, a touch pad, a trackball, and the like.

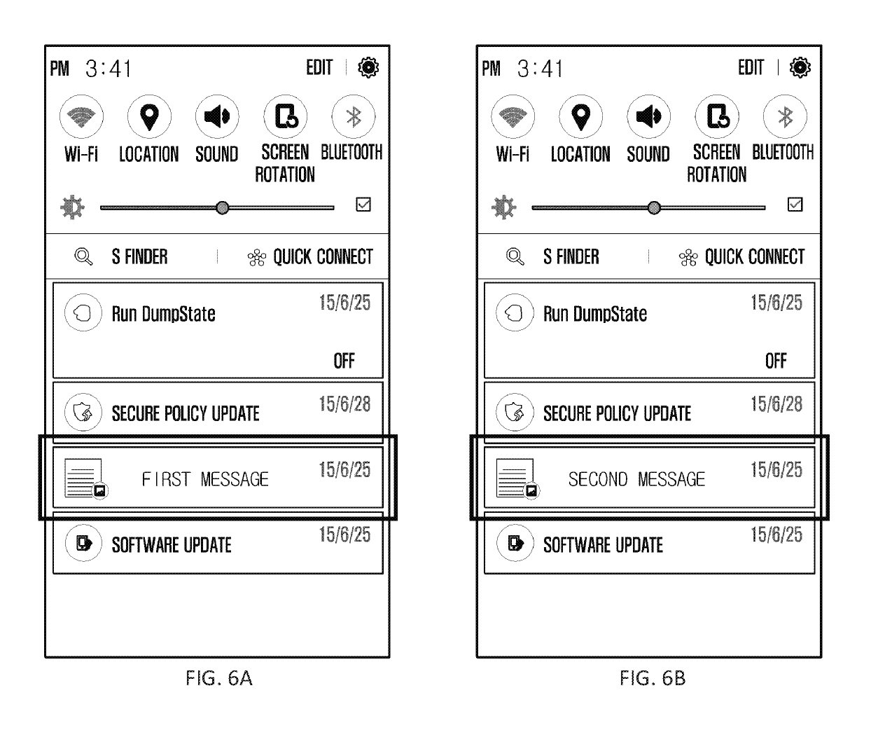

FIGS. 6A and 6B illustrate screens that show, when a number of messages arrive, a method of performing the notification control (mute alert) for messages after the first message according to various embodiments of the present disclosure. In an example embodiment, FIG. 6A is a screen showing a state where the electronic device 400 has received the first message from at least one external device 406, and FIG. 6B is a screen showing a state where the electronic device 400 has received the second message.

As shown in FIG. 6A, the electronic device 400 provides an arrival notification of a first message received from an external device 406. After that, as shown in FIG. 6B, when the electronic device 400 receives a second message from the external device 406, via the same application, within a specified period of time (e.g., 2˜5 minutes), the processor 470 is capable of performing the notification control (e.g., mute alert) for the second message. In an embodiment, when the electronic device 400 receives a message via different respective applications, within a period of time to provide a normal alert, more than a specified number of times (e.g., two or more times), the processor 470 may generate a normal alert.

In an embodiment, the specified period of time may be set by default when the electronic device 400 is manufactured or according to a user's settings. The specified period of time may be set to a value based on situations where the electronic device 400 is placed.

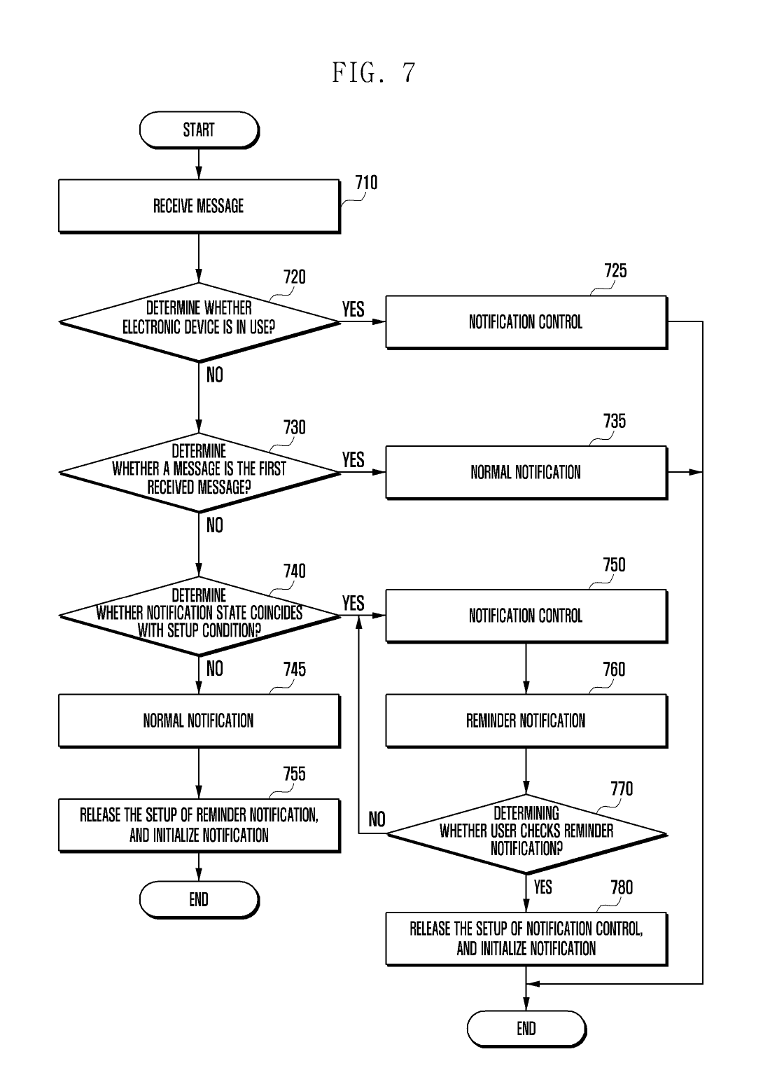

FIG. 7 illustrates a process that describes a default push message notification control method according to various embodiments of the present disclosure.

In an embodiment, the processor 470 is capable of ascertaining that a message is received from at least one external device 406 via the wireless communication unit 410 in operation 710. The message may include at least one of the following: text messages (e.g., short message service (SMS), long message service (LMS), and multimedia message service (MMS)), mobile messengers (e.g., Facebook®, Twitter®, Line® and KakaoTalk®), and the like.

In an embodiment, the processor 470 is capable of determining whether the electronic device 400 is currently in use in operation 720. For example, a condition as to whether the electronic device 400 is currently in use includes: a condition as to whether a user's operation inputs are applied to the input unit 420; a condition as to whether a user's touches are applied to the touch panel 430; a condition as to whether the display 462 is activated; and the like.

When the processor 470 ascertains that the electronic device 400 is currently in use in operation 720, the processor 470 is capable of controlling information set in the notification control setting unit 440 or instructions stored in the memory 450, and performing notification control (mute alert) or normal alert for the received message in operation 725.

Alternatively, when the processor 470 ascertains that the electronic device 400 is not in use but in a standby state in operation 720, the processor 470 is capable of determining whether the received message is the first received message in operation 730.

When the processor 470 ascertains that the received message is the first received message in operation 730, the processor 470 is capable of performing a normal alert for the received push message in a mode, such as a mode for turning on the display, a mode for generating a ring tone or a vibration, in operation 735.

Alternatively, when the processor 470 ascertains that the received message is not the first received message or another message is received in operation 730, the processor 470 is capable of determining whether a notification state of a corresponding message coincides with a setup condition, based on information set by the user in the notification control setting unit 440 or instructions stored in the memory 450 in operation 740.

The setup condition may include a condition within a specified time interval (e.g., 2˜5 minutes), a condition less than the specified number of times of notification control (e.g., 20˜30 times), a notification control condition that the user temporarily set via a notification control setting unit 440. When the setup condition is satisfied, the notification control may be processed. For example, the setup condition may be set in such a way that: a time interval from a previous normal alert is less than a time interval processing the specified notification control; the number of notifications that the notification control has been processed is less than the number of times that the specified notification control can be processed, since a previous normal alert; a message is set by a user to perform notification control.

When the processor 470 ascertains that a notification state of a corresponding message coincides with a setup condition in operation 740, the processor 470 is capable of controlling information set in the notification control setting unit 440 or instructions stored in the memory 450, and performing notification control (e.g., mute alert) for the received message, such as preventing the display from being tuned on, processing a ring tone or a vibration in mute mode, and the like. in operation 750. The user of the electronic device 400 may set the number of times that notification control can be performed via the notification control setting unit 440. When the number of performing notification control is less than the specified number of times, the notification of arrival of a corresponding message may be notification control. On the other hand, when the number of performing notification control is less than the specified number of times, the notification of arrival of a corresponding message may be a normal alert, and the specified number of times may increase to a value greater than the current value.

The processor 470 is capable of performing, at least once, a reminder notification for executing a normal alert for the received message, performed in such a way as to turn on the display and generate a ring tone or a vibration, in operation 760. For example, when the electronic device 400 receives a message from at least one external device 406, the processor 470 provides a reminder notification (turning on the display or generating a ring tone or a vibration) one or more times within a preset period of time (e.g., 20˜50 minutes) to prevent a situation where the user may forget the arrival notification of a particular or important message, which is because the notification is set in such a way that the display is not turned on or a ring tone or a vibration operates in mute mode since the first normal alert (e.g., a sound, a vibration) of the arrival of the message has been made.

The processor 470 is capable of determining whether the user of the electronic device 400 checks the reminder notification in operation 770.

When the processor 470 ascertains that the user of the electronic device 400 has not checked the reminder notification in operation 770, the processor 470 returns to operation 750. On the other hand, when the processor 470 ascertains that the user of the electronic device 400 has checked the reminder notification in operation 770, the processor 470 releases the setup of notification control and initializes the notification of message arrival in operation 780. For example, when the user of the electronic device 400 has checked the reminder notification, the processor 470 may release the setup of notification control and initializes the notification control time interval, the number of processing notification control, and the like, to default values. The user of the electronic device 400 may set the notification via the notification control setting unit 440 of the electronic device 400, such that a message notification of a particular application including advertisements can be controlled to be temporarily notified. When the user releases the notification control, the temporary notification control setup value is released and initialized to a default value.

When the processor 470 ascertains that a notification state of a corresponding message does not coincide with a setup condition in operation 740, the processor 470 is capable of performing a normal alert for the received message, such as turning on the screen, generating a ring tone or a vibration, and the like, in operation 745.

In an embodiment, the number of times that notification control can be performed and the time interval to process notification control, which are set by the user of the electronic device 400, may increase. For example, in a state where the number of times of notification is set to 20, when the user does not check a normal alert at the 21st ring tone or vibration, the set number of times of notification may be increased to 30. In a state where the time interval to process notification control is set to one minute, when the generation of a ring tone or a vibration exceeds one minute, the set notification control time interval may be increased to, for example, one minute and ten seconds.

The processor 470 is capable of releasing the setup of the reminder notification for a received push message, and initializing the notification of arrival of a message in operation 755.

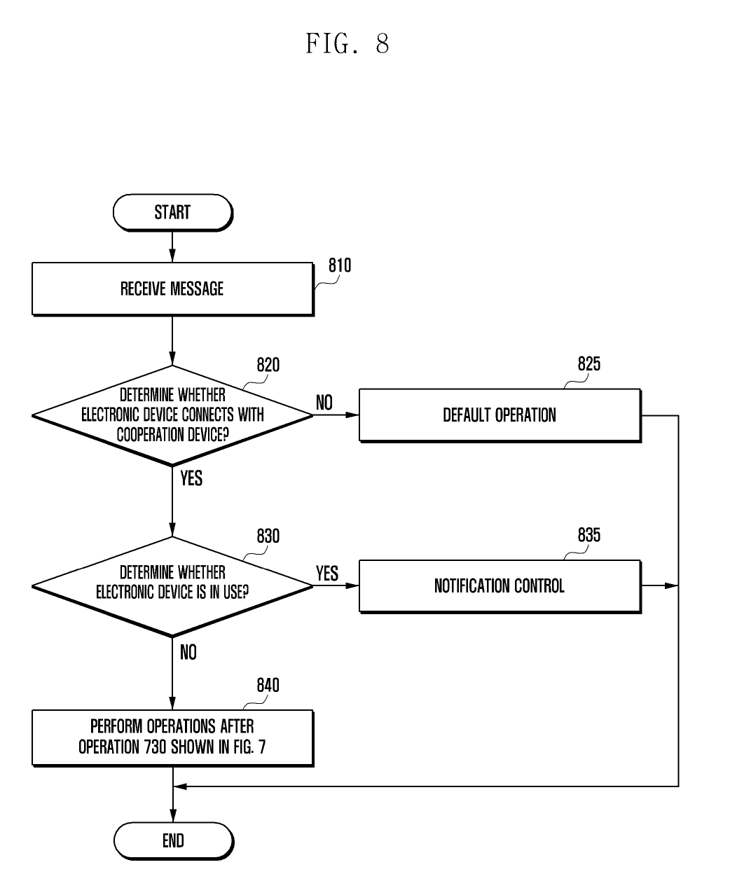

FIG. 8 illustrates a process that describes a message notification control method when the electronic device 400 is connected to a cooperation device 402 according to various embodiments of the present disclosure.

The processor 470 is capable of ascertaining that a push message is received from at least one external device 406 via the wireless communication unit 410 in operation 810.

The processor 470 is capable of determining whether the electronic device 400 serving as a main terminal is connected to at least one cooperation device 402 (e.g., wearable terminals, watch type terminals, audio playback systems) in operation 820. The cooperation device 402 and the electronic device 400 are capable of cooperating with each other.

When the processor 470 ascertains that the electronic device 400 serving as a main terminal is not connected to at least one cooperation device 402 in operation 820, the processor 470 is capable of performing the message notification control method, shown in FIG. 7, in operation 825.

On the other hand, when the processor 470 ascertains that the electronic device 400 serving as a main terminal is connected to at least one cooperation device 402 in operation 820, the processor 470 is capable of determining whether the electronic device 400 serving as a main terminal is currently in use by the user in operation 830.

When the processor 470 ascertains that the electronic device 400 serving as a main terminal is currently in use by the user in operation 830, the processor 470 is capable of performing a notification control for the arrival of a message from the cooperation device 402 in operation 835.

On the other hand, when the processor 470 ascertains that the electronic device 400 serving as a main terminal is not in use in operation 830, the processor 470 is capable of performing the message notification control method, shown in FIG. 7, in operation 840.

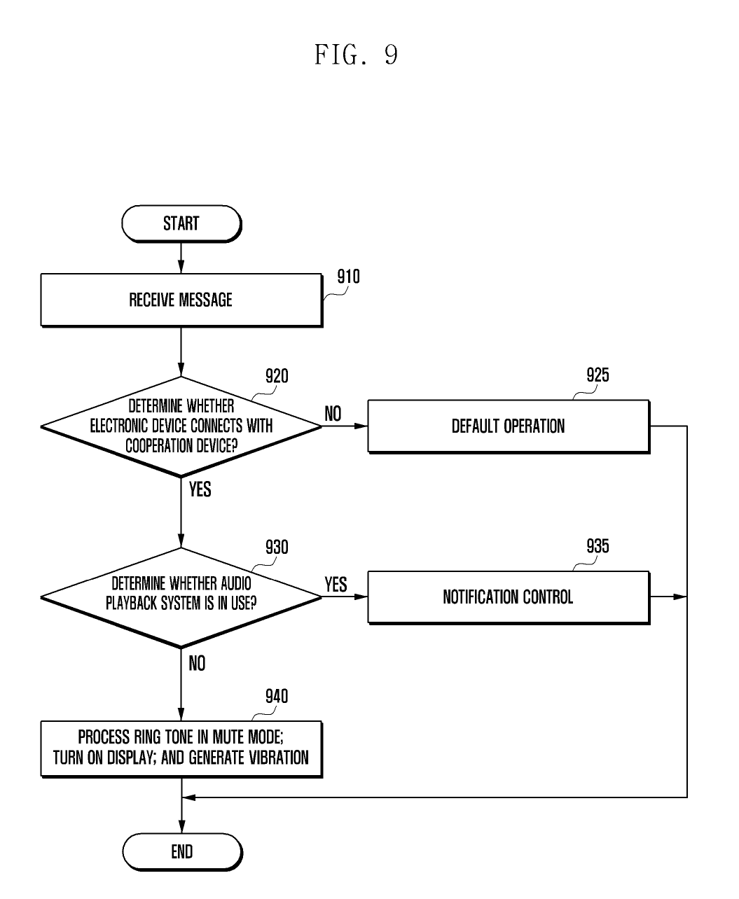

FIG. 9 illustrates a process that describes a message notification control method when the electronic device 400 is connected to an audio playback system according to various embodiments of the present disclosure.

The processor 470 is capable of ascertaining that a push message is received from at least one external device 406 via the wireless communication unit 410 in operation 910.

The processor 470 is capable of determining whether the electronic device 400 serving as a main terminal is connected to at least one cooperation device 402 (e.g., wearable terminals, watch type terminals, audio playback systems) in operation 920. The cooperation device 402 and the electronic device 400 are capable of cooperating with each other.

When the processor 470 ascertains that the electronic device 400 serving as a main terminal is not connected to at least one cooperation device 402 in operation 920, the processor 470 is capable of performing the message notification control method, shown in FIG. 7, in operation 925.

On the other hand, when the processor 470 ascertains that the electronic device 400 serving as a main terminal is connected to at least one cooperation device 402 in operation 920, the processor 470 is capable of determining whether the audio playback system related to a notification sound, one of the cooperation devices 402, is currently in use in operation 930.

When the processor 470 ascertains that the audio playback system is connected to the electronic device 400 serving as a main terminal but is not in use in operation 930, the processor 470 is capable of performing the message notification control method, shown in FIG. 7, in operation 935.

On the other hand, when the processor 470 ascertains that the audio playback system is connected to the electronic device 400 serving as a main terminal and is in use in operation 930, the processor 470 is capable of performing a notification control for the arrival of a message, in such a way as to: process a ring tone in mute mode, turn on the display, and generate a vibration, in operation 940. For example, when the electronic device 400 serving as a main terminal is connected to an audio playback system and the audio playback system is currently in use, the notification control may set in such a way as to only turn on the display and generate a vibration, such that the user can hear audio without interrupting the audio playback. When the electronic device 400 serving as a main terminal is connected to an audio playback system but the audio playback system is not in use, the normal alert is output via the speaker 464 such that the user can hear the notification sound.

According to various embodiments of the present disclosure, when a message arrives, the electronic device is capable of: determining whether, since the first notification of the arrival of a message has been made, the notification of the message arrival is meaninglessly repeated in various situations, such as a notification when the electronic device has not been used for a relatively long period of time, a duplicate notification to a number of cooperation devices, a notification while the electronic device is in use, and the like; and controlling the notification based on the determination, thereby reducing noise and battery power consumption according to the notification.

According to various embodiments of the present disclosure, since the first notification of the arrival of a message has been made, the electronic device is capable of: preventing the display of repeated notification of message arrival from turning on and processing a ring tone or a vibration in a mute mode, thereby reducing noise and battery power consumption according to the notification.

According to various embodiments of the present disclosure, the electronic device is capable of: providing a reminder notification (turning on the display or generating a ring tone or a vibration) one or more times within a preset period of time to prevent a situation where the user may forget the arrival notification of a particular or important message, which is because the notification is set in such a way that the display is not turned on or a ring tone or a vibration operates in mute mode since the first notification of the arrival of a message has been made.

According to various embodiments of the present disclosure, since the first notification of the arrival of a message has been made, the interval and the time for a reminder notification can be adjusted, such that the time of a reminder notification for the message increases and the number of reminder notifications decreases.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a communication circuit;
at least one user interface;
a processor electrically connected to the communication circuit and the at least one user interface; and
a memory electrically connected to the processor,
wherein the memory is configured to store instructions that enable the processor to:
receive a first message from at least one external device via the communication circuit;
provide at least one notification, in a first mode via at least one user interface, in response to the reception of the first message;
detect, after at least one notification has been provided in the first mode, the presence of at least one event related to the electronic device or the user of the electronic device;
receive, after the presence of at least one event has been detected, a second message from at least one external device via the communication circuit; and
provide at least one notification, in a second mode based on the received second message and at least one detected event, or in a first mode after a selected period of time has elapsed.

2. The electronic device of claim 1, wherein the at least one detected event comprises at least one of:
a condition where selected information is obtained from an ambient environment of the electronic device; or
a condition where an input is not applied to at least one user interface within a preset period of time.

3. The electronic device of claim 1, wherein:
the first mode comprises a mode where at least one notification is provided in a first measure; and
the second mode comprises a mode where at least one notification is provided in a second measure that differs from the first measure.

4. The electronic device of claim 1, wherein the instructions further enable the processor to:
obtain at least one of situation information related to the electronic device or the user of the electronic device; and
detect the presence of at least one event based on the obtained situation information.

5. The electronic device of claim 1, wherein the user interface comprises:
a touch panel for viewing a first message or a second message received from at least one external device.

6. The electronic device of claim 1, wherein:
the first mode is a normal alert, when a first message or a second message is received, including at least one of turning on a screen, outputting a ring tone, or making a vibration; and
the second mode is a notification control or a mute alert, when a first message or a second message is received, including at least one of not turning on a screen, not outputting a ring tone, or not making a vibration.

7. The electronic device of claim 1, further comprising:
a notification control setting unit for setting the notification control to normal alerts that are generated within a preset time interval since the presence of a first normal alert, when a first message or a second message is received.

8. The electronic device of claim 7, wherein the notification control setting unit is set to provide a reminder notification one or more times within a preset period of time to prevent a situation where a normal alert for the reception of a particular message may not be notified when the electronic device receives a first message or a second message from at least one external device, where the notification was controlled after the presence of the first normal alert.

9. A method of controlling the notification of a message in an electronic device comprising:
recognizing, by a processor, the reception of the message from at least one external device;
determining, by the processor, whether the electronic device is in use; and
when the electronic device is in use, providing, by the processor, at least one notification, in a mode via at least one user interface.

10. The method of claim 9, wherein the mode is a notification control or a mute alert including at least one of:
not turning on a screen, not outputting a ring tone, or not making a vibration in the electronic device.

11. The method of claim 9, further comprising:
when the electronic device is not in use, determining, by the processor, whether the message received from at least one external device is a first received message; and
when the message received from at least one external device is the first received message, providing, by the processor, at least one notification in another mode via at least one user interface.

12. The method of claim 11, further comprising:
when the message received from at least one external device is not the first received message or is another message, determining, by the processor, whether a notification state of a corresponding message coincides with a setup condition based on information set up to a notification control setting unit or instructions stored in a memory.

13. The method of claim 12, wherein the setup condition comprises at least one of:
a condition within a specified time interval, a condition less than the specified number of times of notification control, or a notification control condition that the user temporarily set via a notification control setting unit.

14. The method of claim 12, further comprising:
when the notification state of the corresponding message coincides with the setup condition, providing, by the processor, at least one notification in a mode via at least one user interface.

15. The method of claim 14, further comprising:
after at least one notification is provided in the mode, providing, by the processor, at least one other notification in another mode, via at least one user interface, based on the setup condition.

16. The method of claim 15, further comprising:
determining, by the processor, whether the other notification provided in the other mode is checked; and
when the other notification is checked, initializing a setup of the electronic device.

17. The method of claim 12, further comprising:
when the notification state of the corresponding message coincides with the setup condition, providing, by the processor, at least one notification, in another mode, via at least one user interface.

18. The method of claim 9, further comprising:
when the electronic device is connected to at least one cooperation device and is in use, providing, by the processor, at least one notification to a cooperation device, in at least one mode, via at least one user interface.

19. The method of claim 9, further comprising:
when the electronic device is connected to at least one audio playback system and is in use, blocking, by the processor, part of the notification function, via at least one user interface, and performing operations of the audio playback system.

20. A non-transitory computer-readable recording medium storing a software program for controlling functions of an electronic device, comprising instructions which enable the electronic device to:
receive a first message from at least one external device;
provide at least one notification, in a first mode via at least one user interface, in response to the reception of the first message;
detect, after at least one notification has been provided in the first mode, the presence of at least one event related to the electronic device or the user of the electronic device;
receive, after the presence of at least one event has been detected, a second message from at least one external device; and
provide at least one notification, in a second mode based on the received second message and at least one detected event, or in a first mode after a selected period of time has elapsed.
